(19) United States
(12) Patent Application Publication
(10) Pub. No.: US 2025/0027679 A1
(43) Pub. Date: Jan. 23, 2025

(54) PUMPLESS TOP-UP WATER HEATING TANK

(71) Applicant: Mixergy Limited, Oxfordshire (GB)

(72) Inventor: Peter ARMSTRONG, Oxfordshire (GB)

(73) Assignee: Mixergy Limited, Oxfordshire (GB)

(21) Appl. No.: 18/684,706

(22) PCT Filed: Aug. 18, 2022
(86) PCT No.: PCT/GB2022/052144

§ 371 Date: Feb. 19, 2024

(30) Foreign Application Priority Data
Aug. 19, 2021 (GB) 2111917.7

(51) Int. Cl. F24H 9/00; F24H 1/20; F24H 15/219; F24H 15/33; F24H 15/37; G05D 23/02

(52) U.S. Cl. CPC F24H 9/0021; F24H 1/201; F24H 15/219; F24H 15/33; F24H 15/37; G05D 23/022

(57) ABSTRACT

A water heating tank comprises a reservoir having a cold water inlet and a hot water outlet; a can disposed in a lower portion of the tank enclosing at least a part of a heater; a chimney extending from the top of the can to an upper portion of the tank. A chimney valve is arranged between the can and the chimney. The chimney valve is configured to prevent water flowing from the can into the chimney when a temperature of water in the can exceeds a first chimney threshold temperature.

The present invention relates to a water heating tank and a method for operating it. In particular, a water heating tank with an electrical heating element that can heat relatively small quantities of water quickly and supply them without the use of a pump.

It is desirable to heat only the amount of water that is needed for use and it is desirable to be able to heat that water quickly, once a user has decided that they need it. In conventional water heating tanks the heating element is located at the base of the tank and when hot water is demanded by the user the cold water at the base of the tank is heated and rises to the top of the tank under the action of a convection current. There is inevitably mixing of the heated water as it rises through the tank therefore reducing the efficiency and speed with which a volume at hot water can be provided at the top of the tank from where is drawn off for use.

There is therefore a need for a water heating tank that can quickly and efficiently provide hot water to a user on demand.

Aspects and embodiments of the invention are described herein and in the appended claims.

According to a first aspect, there is provided a water heating tank comprising: a reservoir having a cold water inlet and a hot water outlet; a can disposed in a lower portion of the tank enclosing at least a part of a heater; a chimney extending from the top of the can to an upper portion of the tank; and a chimney valve arranged between the can and the chimney, the chimney valve being configured to prevent water flowing from the can into the chimney when a temperature of water in the can exceeds a first chimney threshold temperature.

The chimney valve may be configured to prevent water flowing from the can into the chimney when a temperature of water in the can is less than or equal to a second chimney threshold temperature, the second threshold temperature being lower than the first threshold temperature.

The first chimney threshold temperature may be above 60° Celsius, preferably below 65° Celsius, preferably around 62 or 63° Celsius. The second chimney threshold temperature may be below 60° Celsius, preferably below 55° Celsius, further preferably above 50° Celsius.

The chimney valve may comprise a wax motor.

The chimney valve may comprise: a flow stop; and a flow orifice configured to provide a fluid pathway from the can into the chimney, the flow stop being configured block the flow orifice when the temperature exceeds the first chimney threshold temperature thereby to prevent water flowing from the can into the chimney.

The chimney valve may comprise an elastically deformable portion arranged between the flow stop and a drive means of the chimney valve.

The water heating tank may further comprise a can relief valve configured to control a flow of water from the can into the reservoir.

The can relief valve may be driven by the wax motor. Alternatively, the can relief valve may also be driven by its own wax motor.

The can relief valve may be configured to prevent water flowing from the can into the reservoir via the can relief valve when a temperature of the water in the can is less than or equal to a relief threshold temperature; and to allow water to flow from the can into the reservoir via the can relief valve when the temperature of the water in the can exceeds the relief threshold temperature.

The relief threshold temperature may be less than or equal to the first chimney threshold temperature. For example, the relief threshold temperature may be 0.5° C. less than the first chimney threshold temperature, or 1° C. less than the first chimney threshold temperature, or 2° C. less than the first chimney threshold temperature.

The can relief valve may comprise: a shuttle housing comprising at least one relief hole from the shuttle housing to the reservoir; and a flow shuttle configured to move within the shuttle housing, wherein at least one aperture is provided from the can into the shuttle housing, and wherein the flow shuttle is movable between: a first position in which the at least one aperture from the can to the shuttle housing and/or the at least one relief hole is blocked by the flow shuttle, and a second position in which the at least one aperture from the can to the shuttle housing and the at least one relief hole are not blocked by the flow shuttle thereby to allow water to flow from the can to the reservoir via the can relief valve.

The can relief valve may comprise a biasing means arranged to bias the flow shuttle towards the first position.

The flow shuttle may comprise at least one flow channel extending through the flow shuttle to provide a fluid pathway from a first side of the flow shuttle to a second side of the flow shuttle.

The can relief valve and the chimney valve may be provided as a combined valve.

The combined valve may be moveable between: a first configuration in which a fluid pathway is provided between the can and the chimney through the combined valve; and a second configuration in which a fluid pathway is provided between the can and the reservoir through the combined valve but no fluid pathway is provided through the combined valve between the can and the chimney.

The combined valve may be moveable between the first and second positions and a third position in which no fluid pathway is provided out of the can through the combined valve.

The water heating tank may further comprise a throttle arranged between the can and the chimney.

The throttle may be configured to be actuated by the wax motor.

The throttle may be configured to be actuated from outside the tank.

The throttle may have a portion having a conical or frustoconical shape.

The water heating tank may further comprise: a throttle control rod extending from the throttle to outside the tank through a wall of the tank; and a throttle control rod actuator disposed outside the tank, the throttle control rod actuator being configured to be manually operated thereby to actuate the throttle control rod.

The throttle control rod actuator may be located on a bottom wall of the tank.

The water heating tank may further comprise: a wax motor cup configured to support the wax motor; a cup control rod extending from the wax motor cup to outside the tank; and a cup control rod actuator arranged on the outside of the tank, the cup control rod actuator being configured to move the control rod and thereby adjust the location and/or orientation of the wax motor cup, preferably by manual operation of the cup control rod actuator. The cup control rod may further comprise means for simultaneously adjusting the throttle, optionally antagonistically to the adjustment of the wax motor cup.

According to a further aspect, there may be provided a water heating tank comprising: a reservoir having cold water inlet and a hot water outlet; a can disposed in a lower portion of the tank enclosing at least a part of a heater; a chimney extending from the top of the can towards an upper portion of the tank; a throttle arranged between the can and the chimney for adjusting flow from the can into the chimney; a throttle control rod extending from the throttle to outside of the tank; and a throttle control rod actuator arranged outside the tank, the throttle control rod actuator being configured to move the throttle rod and thereby adjust a location and/or orientation of the throttle, preferably by manual operation of the throttle control rod actuator, thereby to allow a user to adjust a throttle setting.

The throttle may have a portion having a conical or frustoconical shape.

The control rod actuator may be located on a bottom wall of the tank.

According to a further aspect there is provided a water heating tank comprising: a reservoir having a cold water inlet and a hot water outlet; a can disposed in a lower portion of the tank enclosing at least a part of a heating element and/or a chimney extending from the top of the can to an upper portion of the tank, wherein either the can, the chimney or both are of a polymer; and a heating element controller configured to cut off power supplied to the heating element when a rate of increase in resistance in the heating element exceeds a threshold value. According to a further aspect there is provided a heating element controller configured to cut off power supplied to a heating element in a water heating tank when a rate of increase in resistance in the heating element exceeds a threshold value. According to a further aspect there is provided a method of controlling a heating element in a water heating tank, the method comprising: determining a rate of increase in resistance in a heating element; and cutting off power supplied to the heating element when the rate of increase in resistance in the heating element exceeds a threshold value.

The invention extends to methods of heating water and operation of the water heating tank as described herein.

Method aspects/features may be implemented as system aspects/features or as apparatus aspects/features and vice-versa. Any feature in one aspect of the invention may be applied to other aspects of the invention, in any appropriate combination.

Embodiments of the invention will now be described, by way of example, with reference to the accompanying drawings in which:

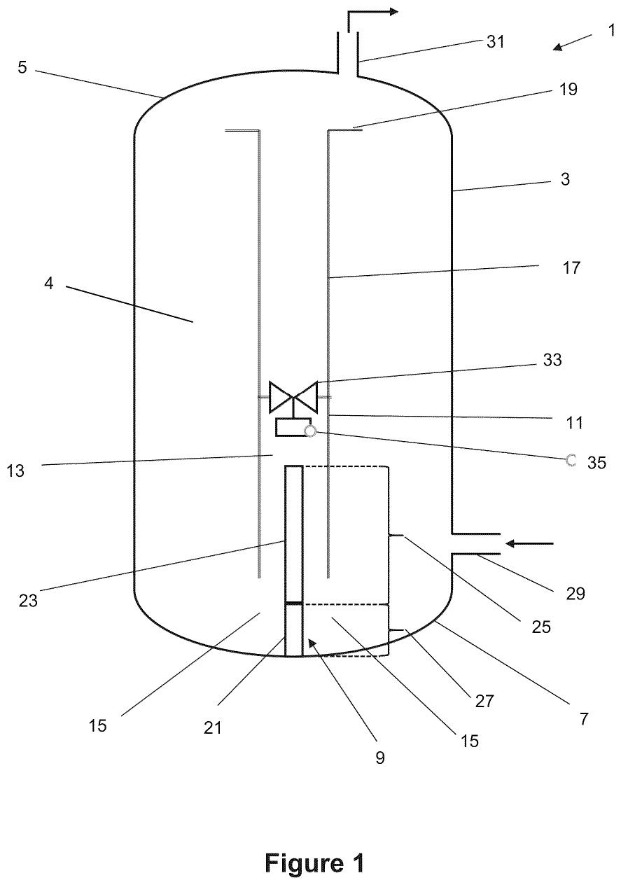

FIG. 1 is a schematic cross-sectional view of a water heating tank having a chimney valve according to an embodiment.

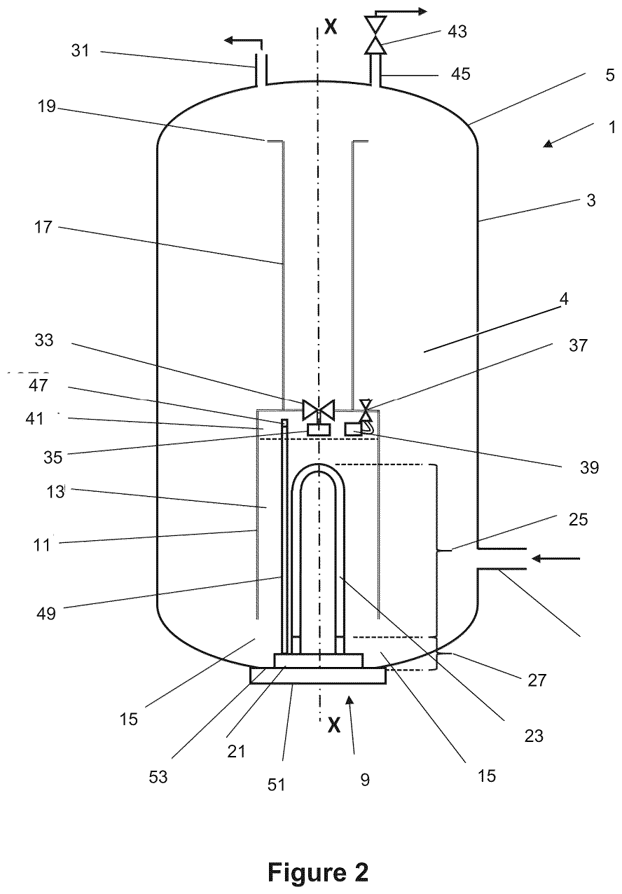

FIG. 2 is a schematic cross-sectional view of a water heating tank having a chimney valve and a can relief valve according an embodiment.

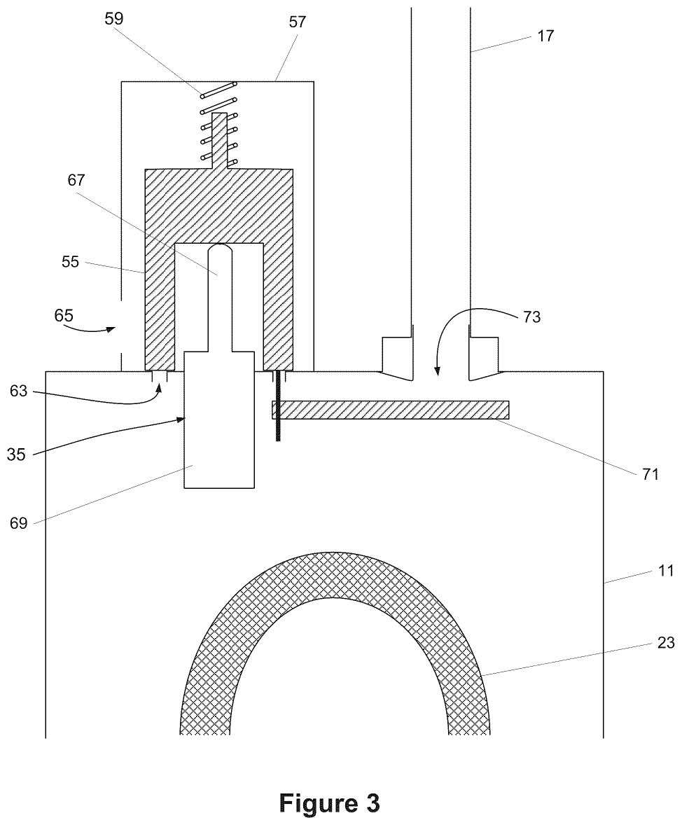

FIG. 3 is a schematic cross-sectional view of a water heating tank having a chimney valve and can relief valve which share a wax motor according to an embodiment.

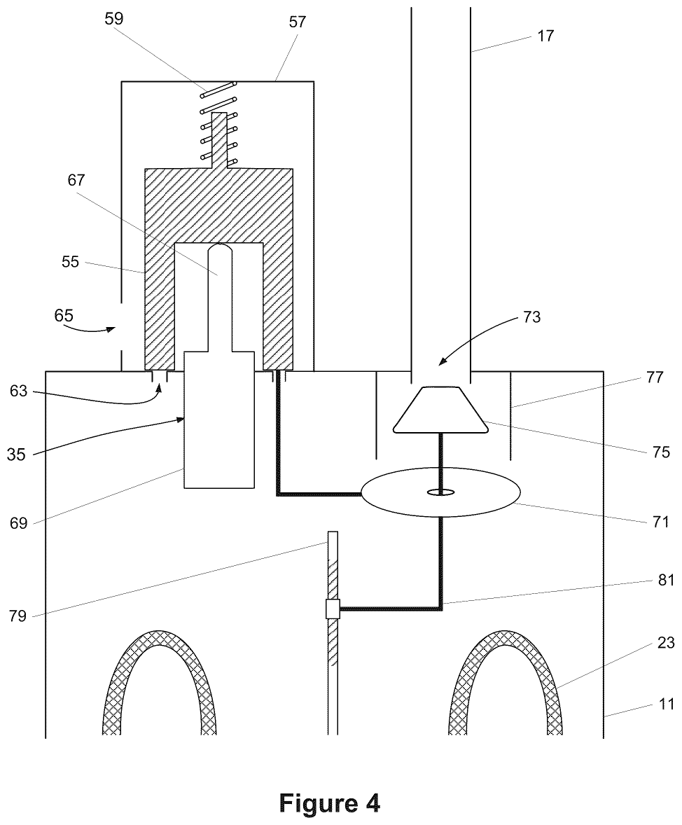

FIG. 4 is a schematic cross-sectional view of a water heating tank having a chimney valve and can relief valve which share a wax motor according to a further embodiment.

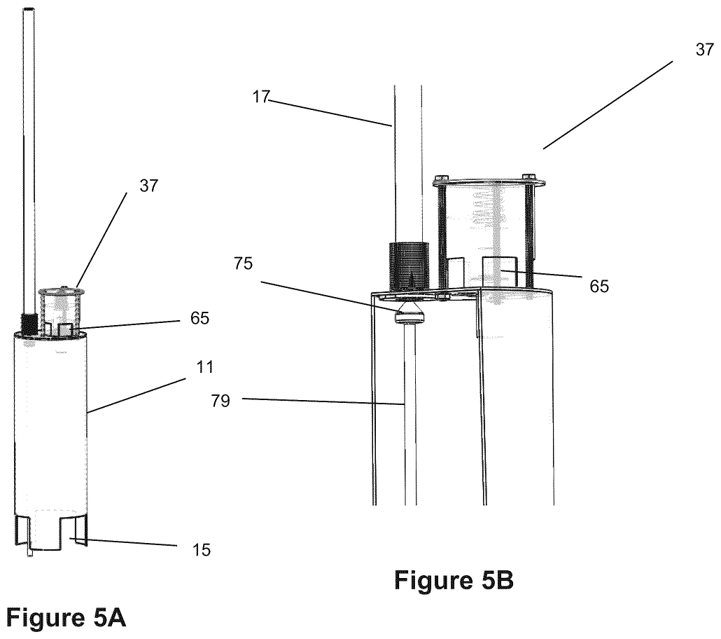

FIG. 5A is a perspective view of a can and chimney arrangement including a throttle.

FIG. 5B is a partially cut away close up view of the arrangement of FIG. 5A.

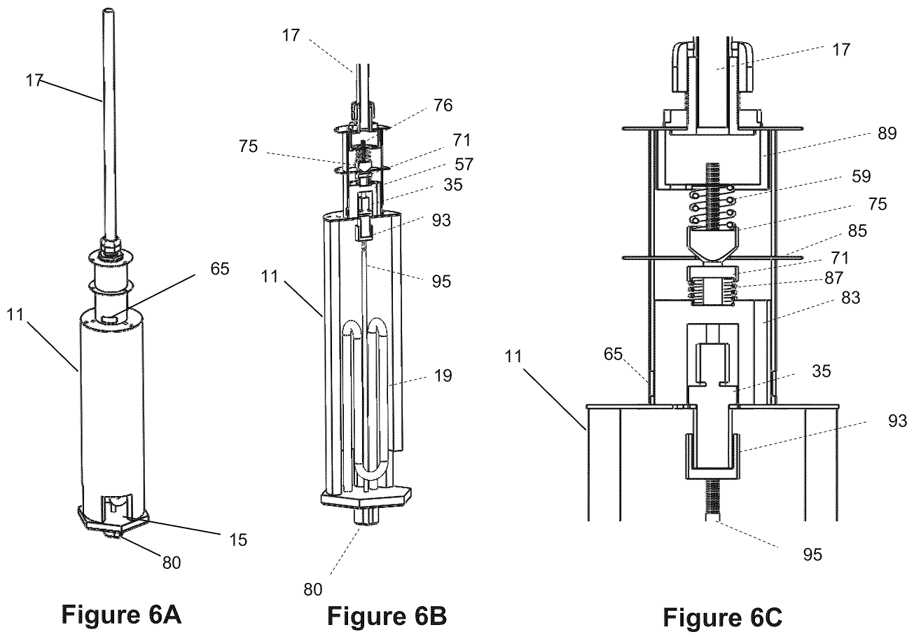

FIGS. 6A-C are respectively: a perspective view, a partially cut away perspective view, and a schematic view of a water heating tank with a combined valve according to an embodiment.

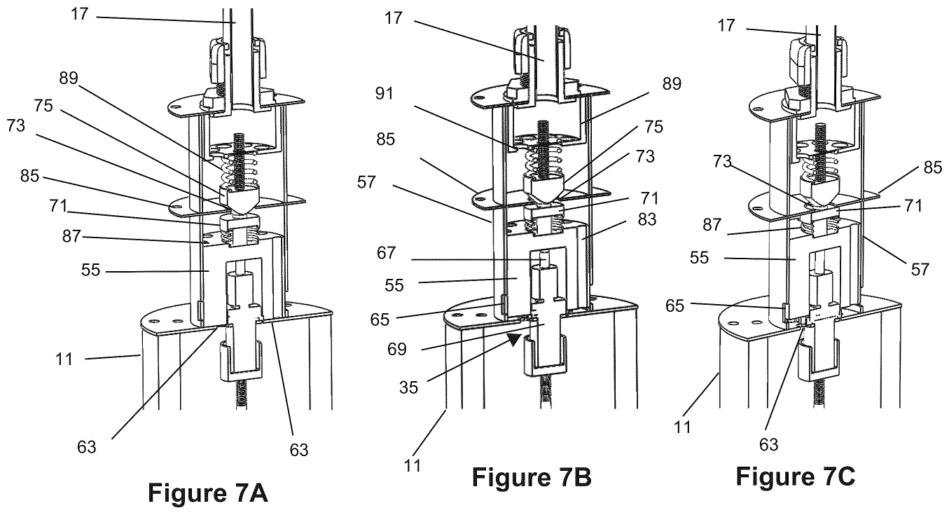

FIGS. 7A-C are perspective sectional views of the combined valve with the flow shuttle in different positions.

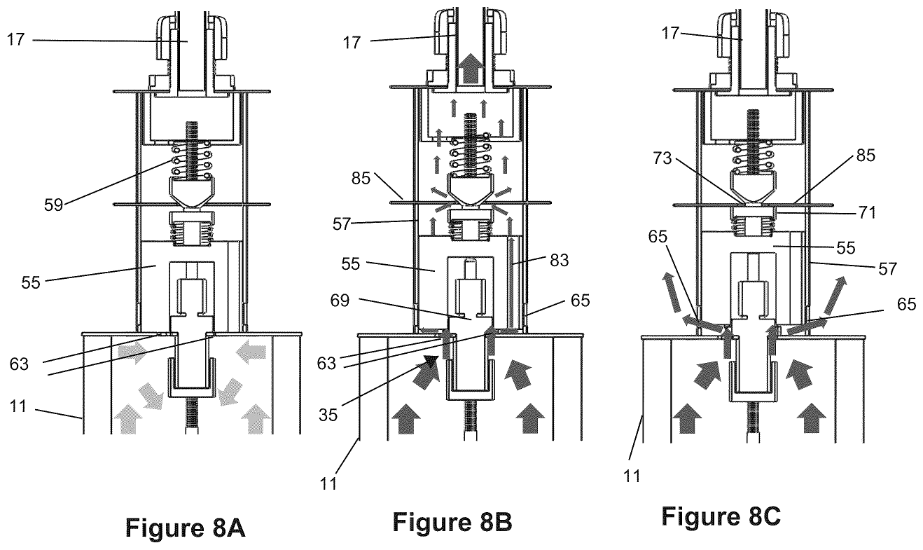

FIGS. 8A-C are diagrams of flow through the can and chimney of the water heating tank of FIGS. 5-7.

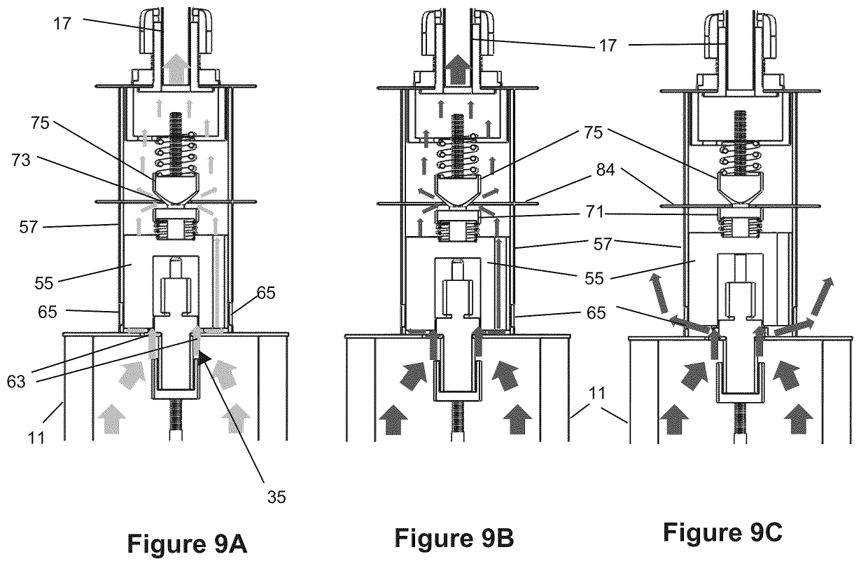

FIGS. 9A-C are diagrams of flow through the can and chimney of the water heating tank of FIGS. 5-7 adapted to provide a minimum flow pathway.

A water heating tank 1 according to the present invention is illustrated in FIG. 1. The water heating tank 1 comprises a hollow cylinder 3 with a domed top wall 5 and a domed bottom wall 7. A water heater 9 (which may be an electrical water heater, also referred to as a heating element) is located at the bottom of the cylinder 3, it is fixed to the bottom wall 7 and it is aligned with the longitudinal axis of symmetry of the cylinder 3. A can 11 is located over the heater 9 and forms a heating zone 13. The can 11 has flow ports 15 arranged around the periphery of its lower portion. A chimney 17 extends vertically upwards from the top of the can 11 and co-axially with the can 11 and the cylinder 3. In the illustrated embodiment, the can 11 and the chimney 17 each have a circular cross-sectional profile of the same constant diameter. In other embodiments it will be seen that the chimney 17 may have a smaller diameter than the can 11, and the central axes of the can 11 and chimney 17 need not align. The chimney 17 terminates close to the top surface of the cylinder 3. An annular plate, or diffuser 19, is located at the top of the chimney 17 and co-axially with it. The region within the tank 1 outside the can 11 and chimney 17 is referred to as the reservoir 4.

The water heater 9 has a base 21 and a heating element 23. The base 21 is fixed to the bottom of the cylinder 3 and the heating element 23 extends vertically upwards from the base 21. The vertical height of the heating element 23 is less than the height of the can 11 and the top of the heating element 19 is located lower than the bottom of the chimney 17. The can 11 can be divided into an active zone 25, in which the heating element is located, and an inactive zone 27.

The flow ports 15 extend parallel to the central axis of the can 11 from the bottom of the cylinder 3 into the active zone 25. The flow ports 15 may be arched, oblong, square or any suitable shape to permit flow of water from the reservoir 4 into the bottom portion of the can 11.

The cylinder 3 has a cold water inlet 29 and a hot water outlet 31.

The can 11, chimney 17 and diffuser 19 are made from a material that is approved for use with potable water, such as 316 stainless steel, or duplex or cross-linked polyethylene.

The tank 1 has a chimney valve 33 that is located between the outlet of the can 11 and the inlet to the chimney 17 in order to partially or fully close off the chimney 17 from the can 11. The chimney valve 33 can be fully opened to allow substantially unimpeded flow of water from the can 11 into the chimney 17. The chimney valve 33 can be fully closed to prevent flow of water from the can 11 into the chimney 17. The valve can be partially opened to restrict the flow of water from the can 11 into the chimney 17.

The chimney valve 33 can be configured to allow, prevent, and restrict flow of water from the can 11 into the chimney 17. The chimney 17 may be controlled by a user and/or the valve may be configured to control the flow of water from the can 11 into the chimney 17 in dependence on a temperature of water in the can 11. This will usually be a temperature of water towards the top of the can 11.

In the illustrated embodiment, the chimney valve 33 is driven by a wax motor 35. Typically, the bulb of the wax motor 35 will be located inside the can 11, towards the top of the can 11. The expansion of the wax in the wax bulb 69 in response to the temperature of the water around the wax bulb 69 will cause the wax motor 35 to drive the chimney valve 33.

Typically, the chimney valve 33 is configured to prevent (or substantially restrict) a flow of water from the can 11 into the chimney 17 when the water is below a lower chimney threshold temperature. This is so that cold water may remain in the can 11 to be heated by the heater 9, without substantial mixing with water in the chimney 17 or the reservoir 4. Once the water has reached a suitable temperature, the valve is configured to permit a flow of the heated water from the can 11 into the chimney 17 to be delivered to the top of the tank 1 for use.

In use, the cylinder 3 is filled with cold water via the cold water inlet 29 and power is provided to the electrical water heater 9. The electrical water heater 9 starts to heat the cold water within the can 11, within the heating zone 13. The temperature of the water increases, its density decreases, and it rises upwards towards the top of the can 11. Cold water is drawn into the can 11 through the flow ports 15 to replace the water that is rising upwards.

In an initial heating phase while a temperature of water in the can 11 is less than or equal to the lower chimney threshold temperature, the chimney valve 33 may be closed or partially open in order to prevent or restrict the flow of water from the can 11 into the chimney 17. This permits a volume of water to be heated in the can 11 more quickly by preventing mixing with the colder water in the chimney 17 and towards the top of the tank 1.

As the temperature in the can 11 increases above the lower chimney threshold temperature, the valve may gradually be opened more fully to allow water to flow from the can 11 more easily into the chimney 17 in order to deliver the heated water to the top of the cylinder 3.

With the valve in an open or partially open configuration, the heated water will pass from the can 11 into the chimney 17, through the height of the chimney 17, and exit the chimney 17 into the top of the cylinder 3. The diffuser 19 inhibits mixing of the hot water exiting the chimney 17 with the cold water in the top of the cylinder 3. A reduction in mixing facilitates the production of a volume of hot water at the top of the cylinder 3 that is sufficiently hot to be used.

In an exemplary scenario, the heating element 19 will heat the water in the can 11 and when the temperature of the water towards the top of the can 11 reaches the lower chimney threshold temperature, for example 50° Celsius, the chimney valve 33 will start to open, driven by the wax motor 35. The chimney valve 33 will be fully open when the temperature in the hot water region 41 reaches a second temperature, for example 55° Celsius.

Once a sufficient volume of hot water has been obtained the electrical water heater 9 is switched off.

In implementing the foregoing, it has been found that in order to obtain a volume of hot water at the top of the reservoir 4 at a temperature suitable for use, typically in a range of 50-60° Celsius, for example, 55° Celsius, the temperature of the water towards the top of the can 11 often exceeds the temperature at the top of the reservoir 4 from which water will be drawn. It has been recognized that under some circumstances this may lead to volumes of water being delivered from the top of the can 11 to the upper portion of the reservoir 4 which may be too hot for safe use. In order to solve this problem, the chimney valve 33 is configured to prevent a flow of water from the can 11 into the chimney 17 if a temperature of the water in the can 11 exceeds an upper chimney threshold temperature, typically in a range of 60-65° Celsius, for example, 62 or 63° Celsius.

Typically, the tank 1 only needs to produce a relatively small volume of hot water. However sometimes a larger quantity of hot water is desired and perhaps all of the water within the cylinder 3 may need to be heated. A thermocline will be created within the water in the cylinder 3, with the hottest water at the top of the cylinder 3 and the coldest water at the bottom of the cylinder 3. When the level of hot water has been pushed close to the bottom of the cylinder 3 it is no longer possible to create a convection current in the chimney 17, because the water passing into the can 11 is the same temperature as the water in the can 11. In this situation, the water heated within the can 11 by the electrical water heater 9 passes from the can 11 into the cylinder 3 through the flow ports 15.

FIG. 2 shows a water heating tank 1 with additional features, in particular, a can relief valve 37. Features in common with FIG. 1 have like reference numerals and are arranged, configured and operate in the same manner unless otherwise described.

In the illustrated embodiment, the can 11 and the chimney 17 each have a circular cross-sectional profile of constant diameter and are aligned coaxially but the chimney 17 has a smaller diameter than the can 11. As before, the chimney 17 terminates close to the top surface of the cylinder 3. An annular plate, or diffuser 19, is located at the top of the chimney 17 and co-axially with it.

The can relief valve 37 is provided in the top of the can 11, in the shoulder of the can 11 adjacent to the chimney 17. The can relief valve 37 is operated by a wax motor 39 which is located within a hot water region 41. The water heated within the can 11 will rise to the top of the can 11 and thus the hot water region 41 contains the hottest water within the can 11. In an open position of the can relief valve 37 water is permitted to flow from the can 11 into the reservoir 4. In a closed position of the can relief valve 37 water is not permitted to flow into the reservoir 4 from the can 11 via the can relief valve 37.

As described in relation to FIG. 1, in use, the cylinder 3 is filled with cold water via the cold water inlet 29 and power is provided to the electrical water heater 9. The electrical water heater 9 starts to heat the cold water within the can 11, within the heating zone 13. The temperature of the water increases, its density decreases, and it rises upwards, through the can 11 towards the top of the can 11. The water flows into the chimney 17 in dependence on whether the chimney valve 33 is closed or open. Cold water is drawn into the can 11 through the flow ports 15 to replace the water that is rising upwards.

As previously described, a thermocline will be created within the water in the cylinder 3, with the hottest water at the top of the cylinder 3 and the coldest water at the bottom of the cylinder 3. When the level of hot water has been pushed close to the bottom of the cylinder 3 it is no longer possible to create a convection current in the chimney 17, because the buoyancy of the heated water is no longer enough to push the hot water at the top of the cylinder 3 further down, i.e., hydrostatic buoyancy forces decrease and the flow rate through the can 11 decreases. In certain situations, the temperature at the top of the cylinder 3 and in the can 11 may become too hot, while water at the bottom of the cylinder 3 may not reach sanitary levels. The can relief valve 37, when open, may provide a relief path once initial heating is achieved, to permit hot water to flow from the top of the can 11 into the reservoir 4 to provide better heating in lower portions of the reservoir 4 and prevent excessive heating in the top part of the reservoir 4 and the can 11.

Therefore, after initial heating, the water heated within the can 11 by the electrical water heater 9 can pass from the can 11 into the cylinder 3 through the passive flow ports 15 as before but also, the hot water can be vented from the can 11 via the vent opening 58. The wax motor 35 is pre-set to open the can relief valve 37 when the temperature of the water within the can 11 exceeds a relief threshold temperature, for example 61 or 62° Celsius. Generally, the relief threshold temperature is less than or equal to the upper chimney threshold temperature so that venting of the can 11 will begin before the water in the can exceeds the upper chimney threshold temperature and flow into the chimney is stopped.

Some additional features of the water heating tank 1 are also illustrated in FIG. 2.

A temperature and pressure relief valve 43 is connected to an outlet 45 from the cylinder 3 and to a drain (not shown). A temperature sensor 47 of a heating element cut-out thermostat 49 is located within the hot water region 41. The hot water region 41 is at the top of the can 11 and above the heating element 19. The temperature sensor 47 is located above the heating element.

The electrical water heater 9, the can 11, chimney 17, diffuser 19 and heating element cut-out thermostat 49 are fixed to a standard sized flange 51, as a sub-assembly, and can be located within the cylinder 3 through an assembly opening 53. To assemble, maintain, or repair the water heating tank 1 the sub-assembly can be removed and replaced via the assembly opening 53.

The heating element cut-out thermostat 49 is pre-set to switch the heating element 19 off when the water at the top of the can 11 reaches a predetermined temperature, typically 80° Celsius.

The temperature and pressure relief valve 43 is also used to limit the temperature of the heated water. When the water within the cylinder 3 exceeds a pre-set temperature then the temperature and pressure relief valve 43 will open and the hot water will be vented to a drain (not shown) via the outlet 45.

Although illustrated in FIG. 2 as each having their own wax motors 35 39, the can relief valve 37 and the chimney valve 33 could be operated by a single wax motor. The wax bulb 69 of the shared wax motor may be located within the hot water region 41. FIGS. 3 and 4 illustrate embodiments of the present invention in which the chimney valve 33 and can relief valve 37 share a wax motor 35.

The can relief valve 37 and the chimney valve 33 can also be combined into a single combined valve. The combined valve could be operated by a single wax motor 35 with the bulb of the wax motor 35 located within the hot water region 41. Embodiments of such a combined valve are illustrated in FIGS. 6 to 9.

FIG. 3 illustrates an embodiment in which the chimney valve 33 and the can relief valve 37 share a wax motor 35. Features in common with preceding figures have like reference numerals and are arranged, configured and operate in the same manner unless otherwise described.

The chimney 17 is provided offset from central axis of the can 11. The can relief valve 37 is provided in the shoulder of the can 11 adjacent the chimney 17.

The can relief valve 37 comprises a flow shuttle 55, a shuttle housing 57, a return spring 59, and a wax motor 35.

The shuttle housing 57 is located on the top of the can 11. The shuttle housing 57 is cup shaped. One or more apertures 63 in the top of the can 11 provide one or more flow paths from the can 11 into the shuttle housing 57. Relief holes 65 in the shuttle housing 57 provide one or more flow paths from the shuttle housing 57 into the reservoir 4.

The relief holes are provided in a side wall of the shuttle housing 57 at a height above where the shuttle housing 57 side wall meets the can 11 such that when the shuttle is vertically displaced by that height (or more) a flow path is provided out of the shuttle housing 57 into the reservoir 4. The hot water from the can 11 may thus be vented, via the shuttle housing 57, into the reservoir 4 by actuation of the flow shuttle 55.

The flow shuttle 55 is arranged to sit in the shuttle housing 57 and be moveable within it. The flow shuttle 55 is configured to have a diameter substantially the same as the internal diameter of the shuttle housing 57 so as to sit snugly within it. The flow shuttle 55 is shorter than the internal height of the shuttle housing 57 so as to permit it to move axially within the shuttle housing 57.

The return spring 59 is arranged between the top of the flow shuttle 55 and the roof of the shuttle housing 57 to bias the shuttle into a first position in which the shuttle abuts the top of the can 11 and block the apertures 63 from the can 11 into the shuttle housing 57. The flow shuttle 55 also blocks the relief holes into the reservoir 4 unless it is displaced vertically such that the bottom of the shuttle rises above the lower edge of the relief holes.

The wax motor 35 comprises a piston 67 and a wax bulb 69. The wax bulb 69 is disposed in the top of the can 11 such that upon expansion of the wax in the wax bulb 69, the piston 67 will urge the shuttle into the shuttle housing 57 (opposing the biasing force of the return spring 59) in order to unblock the apertures 63 in order to allow water to flow from the can 11 through the apertures 63 and into the shuttle housing 57.

The chimney valve 33 is provided in conjunction with the can relief valve 37. In the illustrated embodiment, the chimney valve 33 comprises a flow stop 71 which is actuated by the same wax motor 35 as the flow shuttle 55 of the can relief valve 37.

The flow stop 71 is disposed in the top of the can 11 and connected to the flow shuttle 55 such that as the flow shuttle 55 is displaced upwards into the shuttle housing 57 (i.e., as the temperature at the top of the can 11 increases) the flow stop 71 is displaced upwards towards an opening, or flow orifice 73, from the can 11 into the chimney 17. The connection means between the flow stop 71 and the flow shuttle 55 may be elastically deformable, for example, it may comprise a spring.

The flow stop 71 is arranged such that at a threshold temperature, the flow stop 71 will cover the opening from the can 11 into the chimney 17 and prevent the flow of water therethrough. The slow stop has an area greater than the area of the opening. At and above the threshold temperature, the flow stop 71 abuts the top of the can 11 around the opening and blocks the opening.

In use, at temperatures below the threshold temperature, the flow stop 71 is positioned away from the flow orifice 73. In order words, at temperatures below the threshold temperature, water may be permitted to flow by the chimney valve 33 from the can 11 into the chimney 17 (by convective currents as previously described).

As the temperature increases (but remains below the threshold temperature) the wax motor 35 will displace the flow shuttle 55 upwards into the shuttle housing 57, unblocking the apertures 63 into the shuttle housing 57. As the shuttle rises, the flow stop 71 will similarly rise and be displaced towards the opening between the can 11 and the chimney 17.

Once the shuttle has been displaced sufficiently for a path to exist from the can 11 into the shuttle housing 57 and out of the relief holes, the can 11 may begin to vent into the reservoir 4. Evidently, the height of the relief holes, the restoring force of the return spring 59 and the configuration of the wax motor 35 may each be configured such that venting through the can relief valve 37 occurs at a desired temperature or over a desired temperature range. The can relief valve 37 and the chimney valve 33 are configured such that the relief threshold temperature is less than or equal to the chimney 17 threshold temperature.

At the upper chimney threshold temperature, the flow stop 71 has been displaced sufficiently upwards such that it covers the opening from the can 11 into the chimney 17 and blocks the flow of fluid therebetween. It will be appreciated that the chimney valve 33 threshold temperature may be set by configuring the wax motor 35 and return spring 59, as well as the vertical offset between the flow stop 71 and the shuttle.

At and above the chimney 17 threshold temperature, there is no pathway to permit flow from the can 11 into the chimney 17, and the relief pathway provided by the can relief valve 37 is open. If the connection between the flow shuttle 55 and the flow stop 71 is deformable, particularly elastically deformable—e.g. by way of a spring (such as discussed in more detail below with reference to the flow stop spring 87) or an elastically deformable flow stop, the flow shuttle 55 may continue to be displaced upwards as the temperature of the wax bulb 69 increases even after the flow stop 71 is prevented from travelling further upwards by the top of the can. In general, it will be appreciated that the flow stop 71 need not be connected directly to the flow shuttle 55 but may be arranged in any configuration that permits the drive means (in this case the wax motor) to deliver drive to the flow stop 71 as well as the wax motor. The (elastically deformable) connection means may thus directly connect the flow stop 71 to the drive means and may deform should the drive means ‘overshoot’, that is, should the drive means attempt to drive the flow stop beyond the position in which it is blocking the flow orifice. This may prevent damage to the flow stop, the drive means and surrounding structures.

As illustrated in FIG. 4, a throttle 75 may also be provided arranged between the can 11 and the chimney 17. The throttle 75 is configured to modulate the flow of water from the can 11 into the chimney 17. In the illustrated embodiment, the throttle 75 operates independently of the flow stop 71.

A skirt 77 surrounding the flow orifice 73 is provided depending from the roof of the can 11 into the upper region of the can 11. The flow stop 71 is configured such that the flow stop 71 abuts the skirt 77 above the threshold temperature in order to block the flow pathway from the can 11 into the chimney 17 through the flow orifice 73. It will be appreciated that the skirt 77 is an optional feature and the flow stop 71 may be configured to operate as in relation to FIG. 3—in that case the throttle 75 may be positioned in the chimney 17 above the flow orifice and may not extend through the flow orifice 73. Although not shown in FIG. 4, an elastically deformable connection means (such as a spring or an elastically deformable flow stop element) is preferably included between the drive means (the wax motor 35) and the flow stop 71, to accommodate possible overshoot of the drive means.

A further exemplary arrangement of a flow orifice 73, flow stop 71 and throttle 75 is illustrated in FIGS. 6B-9C in respect of the combined valve but may equally be suitable in a non-combined valve.

The throttle 75 has a substantially frustoconical shape and is axially aligned with the chimney 17. The throttle 75 is configured to be displaceable axially along the central axis of the chimney 17. The throttle 75 may thus be moved upwards and downwards relative to the flow orifice 73 to vary the area of the flow pathway from the can 11 to the chimney 17 through the flow orifice 73 in order to control the rate of flow therebetween.

The throttle 75 is attached to a control rod 79 via a throttle attachment 81. In the illustrated embodiment, the throttle attachment 81 extends through a central hole in the flow stop 71. The throttle attachment 81 fits snugly through the hole in the flow stop 71 such that there is no gap between the hole in the flow stop 71 and the throttle attachment 81 and water may not flow between them.

The control rod 79 extends vertically (in this case along the central axis of the can 11) from outside the bottom of the water heating tank 1, through the domed bottom wall 7 of the tank 1 towards the top of the can 11. A user may actuate the control rod 79 to set the vertical displacement of the throttle 75 in order to vary the rate of flow from between the can 11 and the chimney 17. The control rod 79 may terminate in a control rod actuator (not shown) outside the tank 1, such that a user may manually actuate the control rod 79 to set the height of the throttle 75. The control rod 79 may have a threaded portion (not illustrated) such that a user by set the height of the throttle 75 by rotating the control rod actuator on the bottom wall 7 outside the tank 1.

FIGS. 5A-B illustrates a manually operated throttle 75 provided in a water heating tank 1 without a chimney valve 33.

In the illustrated embodiment, the throttle 75 sits atop a control rod 79 which extends from the throttle 75 out through the base of the water heating tank 1. As previously described, the throttle 75 may be displaced vertically by actuation of the threaded control rod 79 from outside the tank 1 in order to vary the size of the flow pathway through the flow orifice 73 between can 11 and chimney 17. The control rod 79 may be threaded and may be actuated manually by a user rotating a control knob, or other suitable actuator. In the illustrated embodiment, the flow orifice 73 is simply the opening between the can 11 and the chimney 17 and no skirt 77 is provided. The control rod 79 is provided aligned axially with the throttle 75 and the chimney 17 which is offset from the central axis of the can 11. The control rod actuator is preferably located on the outside of the tank, centrally on the bottom wall.

The temperature of the cold water drawn into the tank 1 from the cold water inlet may vary seasonally, for example, being coldest in the winter and warmest in the summer. A user of the water heating tank 1 may therefore wish to vary the position of the throttle 75 in any of the water heating tanks 1 described herein, to restrict or increase the flow through the chimney valve 33 on a seasonal basis. It may be advantageous, for example, to have flow be relatively restricted in the winter such that water is retained in the active zone 25 of the can 11. The denser cold water can cause the flow into the chimney to increase, which can be balanced by restricting the flow with the throttle.

FIGS. 6A-C illustrate an embodiment of the present invention in which the chimney valve 33 and the can relief valve 37 are provided as a combined valve. Features in common with preceding figures have like reference numerals and are arranged, configured, and operate in the same manner unless otherwise described.

The combined valve is arranged between the can 11 and the chimney 17 and is configured to control both the flow of water from the top of the can 11 into the chimney 17 and from the top of the can 11 into the reservoir 4.

The can relief valve 37 is provided similarly as described in relation to FIG. 3. The wax motor 35 is disposed in the top of the can 11 and actuates a flow shuttle 55 with respect to the shuttle housing 57. The shuttle is biased towards the top of the can 11 by a return spring 59 to block the apertures 63 from the top of the can 11 into the shuttle housing 57. Relief holes are provided in the side walls of the shuttle housing 57 to provide a flow path from inside the shuttle housing 57 into the reservoir 4 (when not blocked by the flow shuttle 55).

In order to provide a flow path from the can 11 to the chimney 17, the flow shuttle 55 comprises one or more flow channels 83 which extend through the flow shuttle 55 from the bottom to the top of the flow shuttle 55. The openings of the flow channels 83 on the bottom of the flow shuttle 55 are laterally offset from the location of the apertures 63 from the can 11 into the shuttle housing 57 so that the apertures 63 and the flow channels 83 do not overlap.

The chimney valve 33 comprises a flow stop 71 and a flow orifice plate 85 arranged above the flow shuttle 55. The flow orifice plate 85 is provided between the flow shuttle 55 and the chimney 17. A fluid pathway way is thus provided through the flow orifice 73 of the flow orifice plate 85 through the shuttle housing 57 to the chimney 17.

The flow stop 71 is arranged between the flow shuttle 55 and the flow orifice plate 85. The flow stop 71 comprises a flow stop 71 which is configured to block the orifice in the flow orifice plate 85 when abutting the flow orifice plate 85. The flow stop 71 also comprises a flow stop spring 87 arranged between the flow stop 71 and the flow shuttle 55 and connecting them. The flow stop spring 87 permits the flow shuttle 55 and flow stop 71 to be moved in unison until the flow stop 71 abuts the flow orifice plate 85, at which point the flow shuttle 55 may continue to be displaced upwards by the wax motor 35 while the flow stop 71 is urged against the flow orifice plate 85 without being further displaced.

A throttle 75 is provided substantially above the flow orifice plate 85. The throttle 75 may have a portion with a frustoconical shape with the narrower end arranged proximate the flow orifice 73. The return spring 59 is located between the distal end of the throttle and a return spring seat 89. The throttle 75 and flow shuttle 55 are fixed relative to one another and connected by a rod extending between the throttle 75 and the flow shuttle 55 through the flow orifice plate 85. The rod extends through a central hole in the (annular) flow stop 71. The flow stop 71 is slidable relative to the throttle 75 and the flow shuttle 55 along the rod. The rod and central hole of the flow stop 71 have a snug fit such that water may not flow between the flow stop 71 and the rod. A guide rod 76 is fixed to the throttle 75; the guide rod 76 can move relative to the return spring seat 89 and functions to maintain the throttle 75 and the flow shuttle 55 along the central axis of the combined valve.

The return spring seat 89 is fixed beneath the inlet to the chimney 17. The return spring seat 89 has a number of apertures 91 to permit water to flow therethrough and into the chimney 17.

A wax motor cup 93 is provided to hold the wax motor bulb. The wax motor cup 93 is connected to a control rod 95 which extends from outside the bottom wall 7 of the tank 1, through the bottom wall 7 of the tank 1 and upwards to the bottom of the wax motor cup 93. Similarly to the throttle arrangement illustrated in FIG. 3, the control rod 95 terminate in an actuator 80 located outside of the tank 1 such that the control rod 95 may be actuated by a user to set a vertical height of the wax motor cup 93. This may provide for a variable vertical offset of the wax motor 35 (and therefore of the flow shuttle 55). This may allow calibration of the valve driven by the wax motor 35, for example, setting threshold temperatures or an initial position of the flow shuttle.

FIG. 7A shows the combined valve in a first (can heating) position during an initial heating phase. The return spring 59 urges the flow shuttle 55 such that it blocks the apertures 63 from the can 11 into the shuttle housing 57 thereby preventing water from flowing from the can 11 into the chimney 17. The flow stop 71 (which is connected to the top portion of the flow shuttle 55 by the flow stop spring 87) is located away from the flow orifice plate 85 such that a fluid pathway exists from the region of the combined valve below the flow orifice plate 85, to the region above the flow orifice plate 85. The throttle 75 (which is fixed relative to the flow shuttle 55) is in its downward-most position to restrict flow through the flow orifice 73.

FIG. 7B shows the combined valve in a second (‘chimney flow’) position during a secondary heating phase. The wax in the wax bulb 69 of the wax motor 35 is heated by the surrounded water causing it to expand. The wax motor piston 67 has thus urged the flow shuttle 55 upwards away from the top of the can. A fluid pathway thus exists from the can 11 into the shuttle housing 57. The fluid pathway also extends through the flow shuttle 55 via the flow channels 83 into the region below the fluid orifice plate 85. The flow stop 71 is closer to the flow orifice plate 85 than in the first position, so may slightly restrict the fluid pathway around the flow stop 71 and through the flow orifice 73, but the flow stop 71 is not blocking the flow orifice 73. The throttle 75 has moved upwards and so is less restrictive of flow through the flow orifice 73. The fluid pathway thus continues through the flow orifice 73 and on through the apertures 91 in the return spring seat 89 and into the chimney 17. In the second position, therefore, there is a fluid pathway between the can 11 and the chimney 17 so water may flow from the can 11 into the chimney 17 driven by convection.

The flow shuttle 55 is displaced upwards by less than the height of the lower edge of the relief holes 65 in the shuttle housing 57. The flow shuttle 55 thus blocks the relief holes 65 and there is no fluid pathway from the shuttle housing 57 directly into the can, and consequently the fluid pathway from the top of the can 11 does not exit into the reservoir 4 in the shuttle housing 57. In other words, the can relief portion of the combined valve is closed.

FIG. 7C shows the combined valve in a third (‘venting’) position during a venting phase. This position may be achieved when the water in the top of the tank 1 is very hot, and so the wax motor 35 has driven the flow shuttle 55 (and consequently the flow stop 71) into a larger vertical displacement than in the second position.

In this third position, the flow stop 71 has been displaced vertically such that it abuts the flow orifice plate 85 and blocks the flow orifice 73. As such, there is no longer a fluid pathway from the can 11 into the chimney 17 through the combined valve. The flow shuttle 55 has been displaced upwards by a vertical distance greater than the height of the lower edge of the relief holes 65 in the shuttle housing 57. As such, there is a fluid pathway from the can 11 into the shuttle housing 57, via the apertures 63 in the can, and further from the shuttle housing 57 into the reservoir 4, via the relief holes 65. In this third position, therefore, water may flow from the top of the can 11 into the reservoir 4 via the shuttle housing 57 but not via the chimney 17.

This allows the hot water at the top of the can 11 to be vented into the reservoir 4 directly much lower down than the top of the chimney 17. The presence of the flow stop spring 87 between the flow stop 71 and the flow shuttle 55 permits that the flow shuttle 55 may continue to move upwards once the flow stop 71 is abutting the flow orifice plate 85 and blocking the flow orifice 73. This may permit a greater area of the relief holes 65 to be uncovered to increase the fluid pathway from the top of the can 11 through the relief holes 65 such that as the temperature continues to increase, the combined valve may be able to vent the hot water more easily.

It will be appreciated that by varying, for example, the height of the relief holes 65, the relative distance between the flow shuttle 55 and the flow stop 71, and/or the initial position of the flow shuttle 55 or wax motor 35, that ‘hybrid’ positions of the combined valve may be provided. That is, positions in which there is a fluid pathway both through the flow orifice 73 and into the chimney 17 and outwards into the reservoir 4 through the relief holes 65 of the shuttle housing 57 such that the combined valve may both vent hot water directly into the reservoir 4 near the top of the can 11 and allow water to flow from the top of the can 11 into the chimney 17.

FIGS. 8A-C and 9A-C illustrate fluid pathways through the combine valve in different positions of the combined valve.

In use, as illustrated in FIG. 8A, in an initial (‘can heating’) phase when the heating element is first switched on and water in the can 11 is less than or equal to the lower chimney threshold temperature, the flow shuttle 55 is urged firmly against the top of the can 11 by the return spring 59 and blocks the aperture from the can 11 into the shuttle housing 57 thereby preventing any water flowing from the top of the can 11 into either the reservoir 4 or the chimney 17.

FIG. 8B illustrates, a secondary (‘chimney flow’) heating phase in which the temperature of the water in the can 11 is greater than the lower chimney threshold temperature and less than or equal to the upper chimney threshold temperature. In this case, the temperature of the water in the can 11 is also less than or equal to the can relief threshold temperature. The wax in the wax bulb 69 of the wax motor 35 expands sufficiently to urge the flow shuttle 55 vertically into the shuttle housing 57 such that water may flow into the shuttle housing 57 through the apertures 63 in the top of the can 11 and may further flow upwards through the flow channel(s) 83 in the flow shuttle 55 towards the flow orifice plate 85, through the flow orifice plate 85 and up into the chimney 17 driven by a convection current. Since the temperature does not exceed the can relief temperature threshold, the flow shuttle 55 is not sufficiently vertically displaced to unblock the relief holes 65.

FIG. 8C illustrates the fluid pathway during a venting phase, in which the temperature of the water in the can exceeds the upper chimney threshold temperature and the can relief temperature threshold. The flow shuttle 55 and the flow stop 71 have been raised such that the flow stop 71 abuts the flow orifice plate 85 and blocks the flow orifice 73 thus preventing any further flow of water from the can 11 into the chimney 17. The flow shuttle 55 has been raised sufficiently such that the relief holes 65 in the side of the shuttle housing 57 are no longer covered and a flow pathway is provided from the can 11, into the shuttle housing 57 and out through the relief holes 65, thus allowing hot water to be vented from the top of the can 11 into the reservoir 4 driven by convection.

FIG. 9A illustrates an initial heating phase (‘can heating’+‘chimney flow’) during which a minimum flow pathway is provided from the can 11 into the chimney 17 to allow a flow of water from the can 11 into the chimney 17. In other words, there is no lower chimney threshold temperature below which flow from the can 11 into chimney 17 is completely prevented and, so long as convection currents allow, flow between the can 11 and the chimney 17 may occur in the initial heating phase. The initial position of the flow shuttle 55 therefore does not cover the apertures 63 from the can 11 into the shuttle housing 57, although the relief holes 65 are covered. Since the shuttle may only be displaced a short distance above the apertures 63 of the can, and the throttle 75 is low enough to substantially restrict flow through the flow orifice 73, only a rather small flow of water may be driven by convection though the minimum flow pathway.

By providing a minimum flow pathway, even in the event that the combined valve jams some hot water may still be delivered from the can 11 into the chimney 17 and to the top of the tank 1, albeit at a reduced rate. In addition, this arrangement may enhance the initial heat transfer to the wax motor 35 since it may permit hot water to surround part of the wax motor 35 disposed above the top of the can 11 within the shuttle housing 57. Hysteresis in the wax motor can cause a lag and overshoot of the wax motor 35 response on heating, leading to instability in some circumstances. The minimum flow path may permit more gradual and uniform heating of the wax motor and help prevent instability.

FIGS. 9B and 9C proceed similarly to those described in relation to FIGS. 8B and 8C. Once the lower chimney threshold temperature is reached, the wax motor piston raises the flow shuttle 55, the flow stop 71 and the throttle 75 to permit water to flow through the assembly from the can 11 to the chimney 17. At the threshold temperature, the flow stop 71 abuts the flow orifice plate 85 and prevents further flow of hot water from the can 11 into the chimney 17. The flow shuttle 55 is, at that point, raised sufficiently that water may flow from the can 11 into the shuttle housing 57 and out through the relief holes 65 into the reservoir 4.

In some examples the can and the chimney are of a plastic (i.e. a polymer) such as a thermoplast (e.g. a high-density polyethylene, HDPE). Using a plastic may permit reducing heat losses and reducing the cost of production, and can therefore be advantageous. However, if the heating element is switched on without the tank being filled, the plastic can and chimney are at risk of melting in the region of the heating element. If an installer forgets to fill a tank with water prior to testing the heating element the can and/or chimney may become damaged. To solve this problem, there may be provided a control scheme to protect against inadvertent heat damage in a plastic can and/or chimney. When the heating element warms up in air instead of in water a rapid increase in electrical resistance in the heating element is observed. Therefore if a rapid increase in resistance in the heating element is observed, a control element quickly switches the heating element off before it overheats the plastic can/chimney parts. It is observed that this can be quite effective. A suitable cut-off threshold for the rate of increase in resistance in a heating element can be determined for a specific heating element, for example by testing. Other metrics related to a heating element's resistance—such as power consumption or conductivity—can be used in a similar manner.

In the illustrated examples the chimney is shown as extending in a vertical direction upward from the can, but in some examples the chimney may extend in a horizontal direction from the can, or at an upward angle between horizontal and vertical.

In an alternative to the example illustrated in FIG. 3 a mechanism for adjusting the location of the wax motor is provided similar to the wax motor cup 93 and control rod 95 extending from outside the tank 1 illustrated in FIG. 6C. This may enable calibration of the chimney valve 33 and the can relief valve 37 (e.g. for fine tuning of threshold temperatures).

In an alternative to the example illustrated in FIG. 4 a mechanism for adjusting the location of the wax motor is provided (similar to that described in the preceding paragraph) in addition to the mechanism for adjusting the location of the throttle.

In a further alternative to the example illustrated in FIG. 4 a joint mechanism for adjusting the location of the wax motor and the throttle is provided. In this example a single joint control rod is provided such that when the wax motor 35 is adjusted in one direction, e.g. upwards, the throttle is adjusted in the opposite direction, e.g. downwards. This can permit correct adjustment of the can relief valve and the throttle relative to one another.

It will be understood that the present invention has been described above purely by way of example, and modifications of detail can be made within the scope of the invention.

Reference numerals appearing in the claims are by way of illustration only and shall have no limiting effect on the scope of the claims.

1. A water heating tank comprising:
a reservoir having a cold water inlet and a hot water outlet;
a can disposed in a lower portion of the tank enclosing at least a part of a heater;
a chimney extending from the top of the can to an upper portion of the tank; and
a chimney valve arranged between the can and the chimney, the chimney valve being configured to prevent water flowing from the can into the chimney when a temperature of water in the can exceeds a first chimney threshold temperature.

2. The water heating tank of claim 1, wherein the chimney valve is configured to prevent water flowing from the can into the chimney when a temperature of water in the can is less than or equal to a second chimney threshold temperature, the second threshold temperature being lower than the first threshold temperature.

3. The water heating tank of any preceding claim, wherein the chimney valve comprises a wax motor.

4. The water heating tank of any preceding claim, wherein the chimney valve comprises:
a flow stop; and
a flow orifice configured to provide a fluid pathway from the can into the chimney,
the flow stop being configured block the flow orifice when the temperature exceeds the first chimney threshold temperature thereby to prevent water flowing from the can into the chimney.

5. The water heating tank of claim 4, wherein the chimney valve comprises an elastically deformable portion arranged between the flow stop and a drive means of the chimney valve.

6. The water heating tank of any preceding claim, further comprising a can relief valve configured to control a flow of water from the can into the reservoir.

7. The water heating tank of claim 6 when dependent on claim 3, wherein the can relief valve is driven by the wax motor.

8. The water heating tank of claim 6 or claim 7, wherein the can relief valve is configured to prevent water flowing from the can into the reservoir via the can relief valve when a temperature of the water in the can is less than or equal to a relief threshold temperature; and to allow water to flow from the can into the reservoir via the can relief valve when the temperature of the water in the can exceeds the relief threshold temperature.

9. The water heating tank of claim 8, wherein the relief threshold temperature is less than or equal to the first chimney threshold temperature.

10. The water heating tank of any of claims 6 to 9, wherein the can relief valve comprises:
a shuttle housing comprising at least one relief hole from the shuttle housing to the reservoir; and
a flow shuttle configured to move within the shuttle housing,
wherein at least one aperture is provided from the can into the shuttle housing, and
wherein the flow shuttle is movable between:
a first position in which the at least one aperture from the can to the shuttle housing and/or the at least one relief hole is blocked by the flow shuttle, and
a second position in which the at least one aperture from the can to the shuttle housing and the at least one relief hole are not blocked by the flow shuttle thereby to allow water to flow from the can to the reservoir via the can relief valve.

11. The water heating tank of claim 10, wherein the can relief valve comprises a biasing means arranged to bias the flow shuttle towards the first position.

12. The water heating tank of claim 10 or claim 11, wherein the flow shuttle comprises at least one flow channel extending through the flow shuttle to provide a fluid pathway from a first side of the flow shuttle to a second side of the flow shuttle.

13. The water heating tank of any of claims 6 to 12, wherein the can relief valve and the chimney valve are provided as a combined valve.

14. The water heating tank of claim 13, wherein the combined valve is moveable between:
a first configuration in which a fluid pathway is provided between the can and the chimney through the combined valve;
a second configuration in which a fluid pathway is provided between the can and the reservoir through the combined valve but no fluid pathway is provided through the combined valve between the can and the chimney.

15. The water heating tank of claim 14, wherein the combined valve is moveable between the first and second positions and a third position in which no fluid pathway is provided out of the can through the combined valve.

16. The water heating tank of any preceding claim, further comprising a throttle arranged between the can and the chimney.

17. The water heating tank of claim 16 when dependent on claim 3, wherein the throttle is configured to be actuated by the wax motor.

18. The water heating tank of claim 16, wherein the throttle is configured to be actuated from outside the tank.

19. The water heating tank of any of claims 16 to 18, wherein the throttle has a portion having a conical or frustoconical shape.

20. The water heating tank of any of claims 16 to 19, further comprising:
a throttle control rod extending from the throttle to outside the tank through a wall of the tank; and
a throttle control rod actuator disposed outside the tank, the throttle control rod actuator being configured to be manually operated thereby to actuate the throttle control rod.

21. The water heating tank of claim 20, wherein the control rod actuator is located on a bottom wall of the tank.

22. The water heating tank of any of claims 3-21, further comprising:
a wax motor cup configured to support the wax motor;
a cup control rod extending from the wax motor cup to outside the tank; and
a cup control rod actuator arranged on the outside of the tank, the cup control rod actuator being configured to move the control rod and thereby adjust the location and/or orientation of the wax motor cup, preferably by manual operation of the cup control rod actuator.

23. A water heating tank comprising:
a reservoir having cold water inlet and a hot water outlet;
a can disposed in a lower portion of the tank enclosing at least a part of a heater;
a chimney extending from the top of the can towards an upper portion of the tank;
a throttle arranged between the can and the chimney for adjusting flow from the can into the chimney;
a throttle control rod extending from the throttle to outside of the tank; and
a throttle control rod actuator arranged outside the tank, the throttle control rod actuator being configured to move the throttle rod and thereby adjust a location and/or orientation of the throttle, preferably by manual operation of the throttle control rod actuator, thereby to allow a user to adjust a throttle setting.

24. The water heating tank of claim 23, wherein the throttle comprises a portion having a conical or frustoconical shape; and/or wherein the throttle control rod actuator is located on a bottom wall of the tank.

25. A water heating tank comprising:
a reservoir having a cold water inlet and a hot water outlet;
a polymer can disposed in a lower portion of the tank enclosing at least a part of a heating element and optionally a polymer chimney extending from the top of the can to an upper portion of the tank; and
a heating element controller configured to cut off power supplied to the heating element when a rate of increase in resistance in the heating element exceeds a threshold value.
